(19) United States
(12) Patent Application Publication
(10) Pub. No.: US 2026/0177749 A1
(43) Pub. Date: Jun. 25, 2026

(54) OPTICAL WAVEGUIDE SENSOR AND SPECTROSCOPIC ANALYSIS DEVICE

(71) Applicant: FURUKAWA ELECTRIC CO., LTD., Tokyo (JP)

(72) Inventors: Takumi USUKURA, Tokyo (JP); Noritaka MATSUBARA, Tokyo (JP); Ikuo OTA, Tokyo (JP)

(73) Assignee: FURUKAWA ELECTRIC CO., LTD., Tokyo (JP)

(21) Appl. No.: 19/539,253

(22) Filed: Feb. 13, 2026

Related U.S. Application Data
(63) Continuation of application No. PCT/JP2024/037026, filed on Oct. 17, 2024.

(30) Foreign Application Priority Data
Feb. 14, 2024 (JP) 2024-020027

(51) Int. Cl. G02B 6/132; G02B 6/12; G02B 6/125; G02B 6/138

(52) U.S. Cl. CPC G02B 6/132; G02B 6/12002; G02B 6/12004; G02B 6/125; G02B 6/138

(57) ABSTRACT

An optical waveguide sensor includes: a core that extends in a given direction and that guides examination light; a cladding that has a refractive index lower than the core and that surrounds at least part of a circumference of the core; and a groove that is positioned on a side of the core in a first direction such that an oozing component of the examination light that is guided by the core leaks, an end face of the groove being positioned on a side of a second direction orthogonal to the first direction with respect to an end of the core.

### CROSS-REFERENCE TO RELATED APPLICATION(S)

This application is a continuation of International Application No. PCT/JP2024/037026, filed on Oct. 17, 2024 which claims the benefit of priority of the prior Japanese Patent Application No. 2024-020027, filed on Feb. 14, 2024, the entire contents of which are incorporated herein by reference.

### BACKGROUND OF THE INVENTION

The present disclosure relates to an optical waveguide sensor and a spectroscopic analysis device.

Sensors that measure components and a density of a substance, etc., by ATR (attenuated total reflection) have been known (for example, Japanese Laid-open Patent Publication No. 2005-61904). The sensors enable an examination on a sample using light (evanescent light) that slightly oozes to the outside of an ATR crystal prism with which the sample is in contact when infrared light is totally reflected in the prism.

### SUMMARY OF THE INVENTION

Sensors of this type will be beneficial, for example, if the sensors make it possible to increase accuracy in manufacturing devices more.

Therefore, it is desirable to obtain an optical waveguide sensor and a spectroscopic device that are new and improved and that make it possible to increase manufacturing accuracy more.

In some embodiments, an optical waveguide sensor includes: a core that extends in a given direction and that guides examination light; a cladding that has a refractive index lower than the core and that surrounds at least part of a circumference of the core; and a groove that is positioned on a side of the core in a first direction such that an oozing component of the examination light that is guided by the core leaks, an end face of the groove being positioned on a side of a second direction orthogonal to the first direction with respect to an end of the core.

In some embodiments, a spectroscopic analysis device includes the optical waveguide sensor.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an exemplary and schematic plane view of an optical waveguide sensor of a first embodiment;

FIG. 2 is a cross-sectional view of the optical waveguide sensor in FIG. 1 in the II-II position;

FIG. 3 is an exemplary and schematic plane view of an optical waveguide sensor of a second embodiment;

FIG. 4 is an exemplary and schematic plane view of an optical waveguide sensor of a third embodiment;

FIG. 5 is an exemplary and schematic plane view of an optical waveguide sensor of a fourth embodiment;

FIG. 6 is an exemplary and schematic plane view of an optical waveguide sensor of a fifth embodiment;

FIG. 7 is a cross-sectional view of the optical waveguide sensor in FIG. 6 in the III-III position;

FIG. 8 is an exemplary and schematic plane view of an optical waveguide sensor of a sixth embodiment;

FIG. 9 is a cross-sectional view of the optical waveguide sensor in FIG. 8 in the IV-IV position;

FIG. 10 is an exemplary and schematic plane view of an optical waveguide sensor of a seventh embodiment;

FIG. 11 is a cross-sectional view of the optical waveguide sensor in FIG. 10 in the V-V position;

FIG. 12 is an exemplary and schematic plane view of an optical waveguide sensor of an eighth embodiment;

FIG. 13 is a cross-sectional view of the optical waveguide sensor in FIG. 12 in the VI-VI position;

FIG. 14 is an exemplary and schematic plane view of an optical waveguide sensor of a ninth embodiment;

FIG. 15 is a cross-sectional view of the optical waveguide sensor in FIG. 14 in the VII-VII position;

FIG. 16 is an exemplary and schematic plane view of an optical waveguide sensor of a tenth embodiment;

FIG. 17 is a cross-sectional view of the optical waveguide sensor in FIG. 16 in the VIII-VIII position; and

FIG. 18 is an exemplary and schematic plane view of an optical waveguide sensor of an eleventh embodiment.

### DETAILED DESCRIPTION

A plurality of exemplary embodiments will be disclosed below. The configurations of the embodiments presented below and the functions and the results (effects) brought by the configurations are examples. Embodiments can be realized by a configuration other than the configurations disclosed in the following embodiments. According to the disclosure, it is possible to obtain at least one of various effects that are obtained because of the configurations (including derivative effects).

The embodiments presented below have similar configurations. Thus, according to the configurations of the respective embodiments, functions and effects similar to those based on the similar configurations are obtained. Similar reference numerals are assigned to those similar configurations and redundant description will be omitted in some cases below.

Each of the drawings is schematic and the dimensions in the drawings are sometimes different from actual dimensions in some cases. In each of the drawings, an X-direction is represented by an arrow X, an Y-direction is represented by an arrow Y, and a Z-direction is represented by an arrow Z. The X-direction, the Y-direction, and the Z-direction intersect with and orthogonal to one another. In the specification, a planer view is a view in a direction opposite to the Z-direction and a plane view is a diagram in the planar view.

### First Embodiment

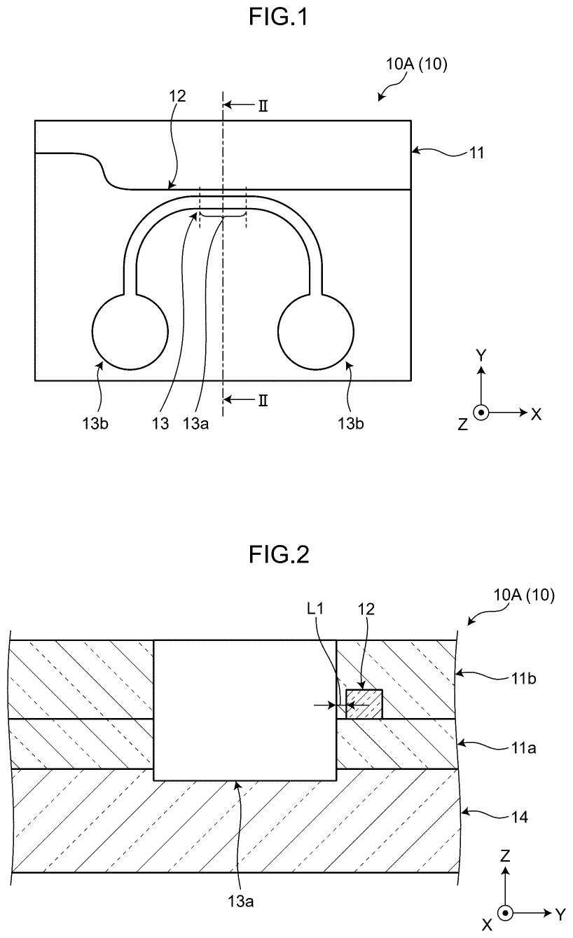

FIG. 1 is a plane view of an optical waveguide sensor 10A (10) of a first embodiment. The optical waveguide sensor 10 has, for example, a shape of a relatively thin and flat cuboid in the Z-direction. The optical waveguide sensor 10, for example, is usable as a spectroscopic analysis device for an examination object. In the specification, a Z positive direction is described as an upper side and a Z negative direction is described as a lower side and, when the optical waveguide sensor 10 is used in a state of partly or entirely being erected (for example, the state of being rotated by 90 degrees such that the X-direction or the Y-direction is the upper side), the positional relationship between the upper side and the lower side in the specification sometimes differ from the positional relationship in use.

The optical waveguide sensor 10, for example, can be configured as a known planar lightwave circuit (PLC). In that case, the optical waveguide sensor 10 integrally includes a substrate that intersects with the Z-direction and extends and a structure that is layered on the substrate in the Z-direction. The substrate is a glass substrate or a silicon substrate. The structure on the substrate includes a core 12 and a cladding 11 surrounding an outer circumference of the core 12. The cladding 11 and the core 12, for example, are made of materials including any one of SiO₂, Si, SiN, InP, GaAs and GaN. The cladding 11 has a refractive index lower than that of the core 12. Note that the cladding 11 may surround at least part of the outer circumference of the core 12 and have an effect of enclosing examination light that is guided through the core 12 and need not necessarily surround the whole circumference of the core 12 (for example, refer to FIG. 7).

In the optical waveguide sensor 10, the core 12 extends in a given direction and guides the examination light. In association with transmission of the examination light, oozing components of the examination light, that is, evanescent light distributes to a portion of the cladding 11 that is near the core 12. It is preferable that the relative refractive-index difference between the core 12 and the cladding 11 be between 0.2% and 15% inclusive to detect the evanescent light. The examination light may be in any one of a single mode and a multimode.

As illustrated in FIG. 1, the optical waveguide sensor 10 extends along a virtual surface that intersects with the Z-direction. The examination light that is input to an end of incidence of the core 12 is transmitted along the core 12 and is output from an output end of the core 12.

FIG. 2 is a cross-sectional view of the optical waveguide sensor 10A in FIG. 1 in the II-II position. As illustrated in FIG. 2, the cladding 11 includes a lower cladding 11a (a first cladding) that is layered on a substrate 14 and an upper cladding 11b (a second cladding) that is layered on the lower cladding 11a. The lower cladding 11a is positioned under the core 12 and a step (not illustrated in the drawings) is formed between the lower cladding 11a and the upper cladding 11b. The lower cladding 11a and the upper cladding 11b, for example, are made of the same material and have the same refractive index; however, they may be made of different materials and have different refractive indices.

The optical waveguide sensor 10 includes a groove 13 that is positioned on a side (a first direction, a Y negative direction herein) of the core 12 such that oozing components of the examination light that is guided through the core 12 leaks. A bottom surface (end face) of the groove 13 is positioned under an end of the core 12 (on a side in a second direction orthogonal to the first direction, a side in the Z negative direction herein). The groove 13 includes an examination area 13a that is positioned approximately at the center and reservoirs 13b that are positioned at both ends. The examination area 13a extends in a given length along the core 12 and a distance L1 between the core 12 and a side face of the groove 13 (a face positioned on the side of the core 12 in the first direction) is at or under a threshold. The threshold is, for example, 5 μm and it is selectable as appropriate according to a subject to be examined. The groove including the examination area 13a between the reservoirs 13b, for example, extends in the cross-sectional shape illustrated in FIG. 2 over the whole zone, that is, in an approximately constant width and an approximately constant depth. A fluid containing an examination object is poured into the reservoirs 13b and accordingly the reservoirs 13b function as a micro fluid channel that transfers the poured fluid. The fluid is, for example, a liquid or a gas, and the fluid may be a viscoelastic body, a flexible solid, or the like. Note that, when the fluid is a viscoelastic body or a solid, the optical waveguide sensor 10 may be used in an erected state.

As described above, the evanescent light of the examination light is distributed to a part of the cladding 11 around the core 12. When the distance L1 between the core 12 and the side face of the groove 13 is, for example, as relatively small as 5 [um] or smaller, the evanescent light of the examination light leaks from the side face of the groove 13 and is absorbed into the examination object in the groove 13. In other words, the mode field of the examination light extends to an inner side of the groove 13 with respect to the side face of the groove 13 on the side of the core 12. In other words, a mode field diameter of the examination light is larger than a distance from the center of the core 12 to the side face of the groove 13 on the side of the core 12. In this case, the intensity of the output light lowers with respect to the intensity of the incident light by the amount of absorption of the examination light into the examination object. The amount by which the intensity of the output light lowers with respect to the incident light lowers (loss intensity), that is, the amount of absorption is a value that differs according to the examination object. Thus, measuring the loss intensity makes it possible to specify the examination object. Note that, because the cladding 11 around the core 12 is thick, leakage of the evanescent light does not occur in portions other than the examination area 13a of the groove 13.

A method of manufacturing the optical waveguide sensor 10 will be described here. First of all, glass films serving as the lower cladding and the core are formed sequentially on the substrate 14. A core layer is processed into a form of a waveguide by lithography and etching and a glass film serving as the upper cladding is formed thereon. Thereafter, the groove 13 is formed on a side of the core 12 by lithography and etching.

As described above, the optical waveguide sensor 10A (10) includes the groove 13 that is positioned on the side of the core 12. As a result, in the optical waveguide sensor 10, it is possible to process the distance L1 between the core 12 and the side face of the groove 13 by accuracy of lithography and further increase accuracy of fabrication.

In the present embodiment, the groove 13 that stores the fluid containing the examination object is formed in the optical waveguide sensor 10 and the side face of the groove 13 serves as a contact face where the evanescent light leaks. According to such a configuration, compared to the configuration in which the groove 13 is not formed, the examination object is easily kept in a measurable state more easily and stably.

### Second Embodiment

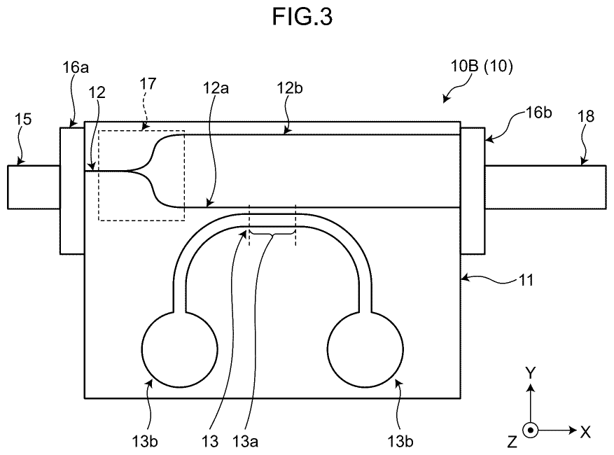

FIG. 3 is a plane view of an optical waveguide sensor 10B (10) of a second embodiment. As illustrated in FIG. 3, in the present embodiment, examination light that is input from an input unit 15 that is a light source or an optical fiber is coupled with the core 12 by a fiber array 16a. The core 12 is branched by an optical branch 17 into a core 12a and a core 12b. Thereafter, the examination light that is guided through the core 12a and the core 12b is coupled with an output unit 18 that is a detector or an optical fiber by a fiber array 16b.

The optical branch 17 may be configured to branch the examination light, and the optical branch 17, for example, may be a power splitter, a WDM (wavelength division multiplexing) splitter, a polarized beam splitter, or a variable splitter.

When the optical branch 17 is a power splitter, the splitter distributes the examination light to each of the cores 12a and 12b at an intensity ratio (for example, 1:1) that is set.

When the optical branch 17 is a WDM splitter, the WDM splitter distributes the examination light to each of the cores 12a and 12b with respect to each different wavelength band. In this case, using a loss intensity in each of the cores 12a and 12b, it is possible to examine an absorption property of the examination object with respect to each wavelength band.

The case where the optical branch 17 is a beam splitter will be described in a third embodiment.

When the optical branch 17 is a variable beam splitter, the variable beam splitter is able to changeably set an intensity ratio for distribution of the examination light to each of the cores 12a and 12b.

The optical branch 17, for example, can be configured as an optical switch. In this case, the optical branch 17 is able to selectively input the examination to any one of the cores 12a and 12b in a time division manner. The optical switch is an example of the optical branch.

In any of the cases, because the optical waveguide sensor 10B (10) includes the optical branch 17, it is possible to reduce the number of light sources compared to the case without the optical branch 17. The relatively simple configuration enables various examinations.

The input unit 15 or the output unit 18 may include a mode filter that removes higher mode components from the examination light. In this case, removal of higher mode components that are unnecessary for the examination makes it possible to further increase accuracy of examination. The mode filter is applicable to the configuration of another embodiment. The place where the mode filter is set is not limited to the input unit 15 or the output unit 18.

### Third Embodiment

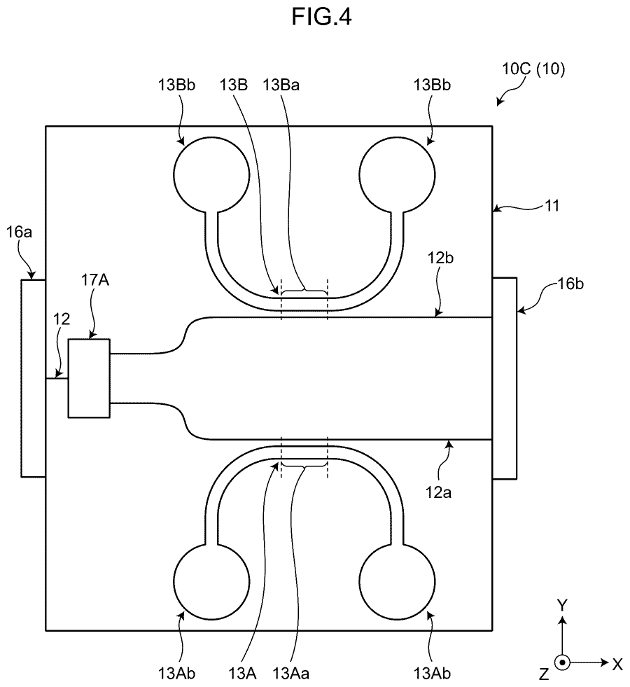

FIG. 4 is a plane view of an optical waveguide sensor 10C (10) of the third embodiment. In the optical waveguide sensor 10C of the present embodiment, an optical branch 17A is a polarized beam splitter that branches the examination light into a TE (transverse electric) polarized component and a TM (transverse magnetic) polarized component. The groove includes a first groove 13A that is positioned on a side of the core 12a guiding light of the TE polarized component and a second groove 13B that has the same form or a linearly symmetric form as or to that of the first groove 13A with the core 12 in between and that is positioned on a side of the core 12b guiding light of the TM polarized component.

As in the first embodiment, the first groove 13A and the second groove 13B respectively include examination areas 13Aa and 13Ba that are positioned at approximately the centers and include reservoirs 13Ab and 13Bb that are positioned on both sides. The examination areas 13Aa and 13Ba extend along the cores 12a and 12b in a given length and the distances between the cores 12a and 12b and side faces are at or under a threshold.

When the optical branch 17A is a polarized beam splitter, the polarized beam splitter divides the examination light into a TE polarized component and a TM polarized component. In this case, using a loss intensity in each of the cores 12a and 12b, it is possible to examine an absorption property of an examination object with respect to each wavelength band.

### Fourth Embodiment

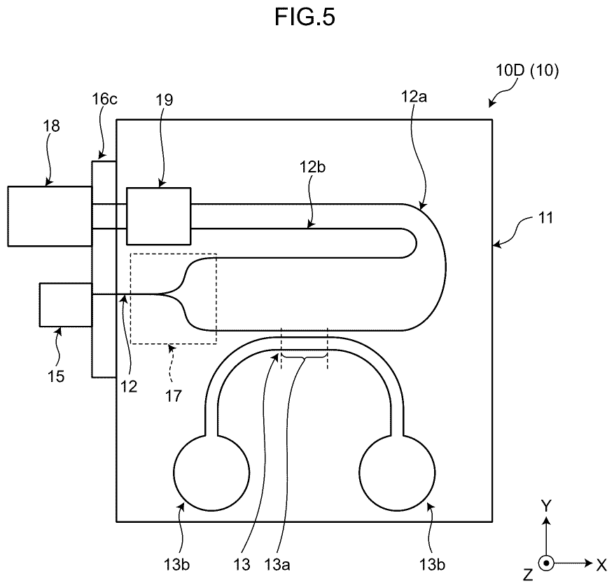

FIG. 5 is a plane view of an optical waveguide sensor 10D (10) of a fourth embodiment. In the optical waveguide sensor 10D, the cores 12a and 12b are formed in a curved manner such that a surface to which examination light is input and a surface from which the examination light is output are an identical surface. An optical circuit 19 is selectable as appropriate according to a subject to be measured and is, for example, an optical interference circuit.

According to the present embodiment, arranging the input unit 15 and the output unit 18 on the identical surface sometimes further reduces the work and costs necessary to manufacture the optical waveguide sensor 10D.

### Fifth Embodiment

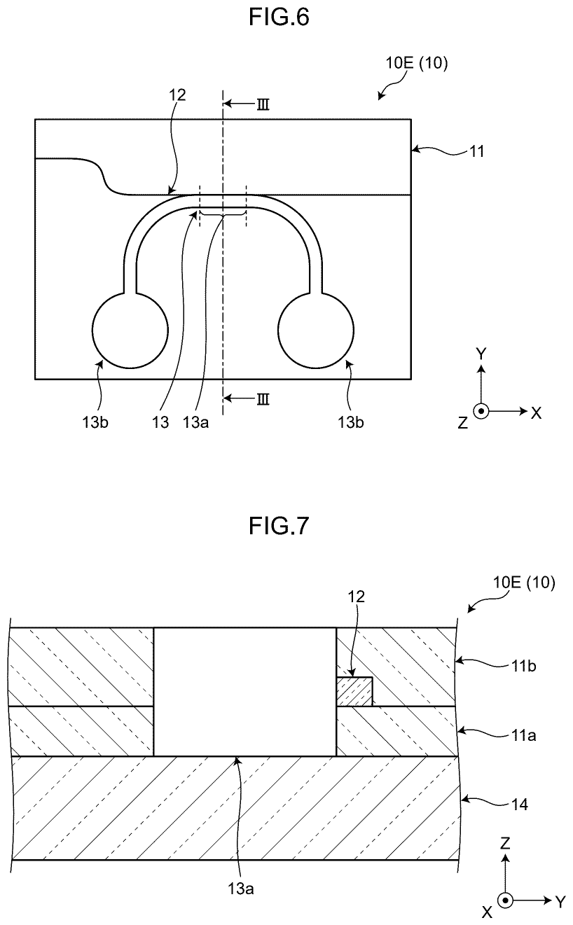

FIG. 6 is a plane view of an optical waveguide sensor 10E (10) of a fifth embodiment. FIG. 7 is a cross-sectional view of the optical waveguide sensor in FIG. 6 in the III-III position. As illustrated in FIG. 7, in the groove 13 of the optical waveguide sensor 10E of the present embodiment, the core 12 and the groove 13 make contact in the examination area 13a.

According to the present embodiment, the core 12 and the groove 13 make contact. As a result, it is possible to maximize an amount of evanescent light of examination light that is absorbed into an examination object and examine the examination object more accurately.

### Sixth Embodiment

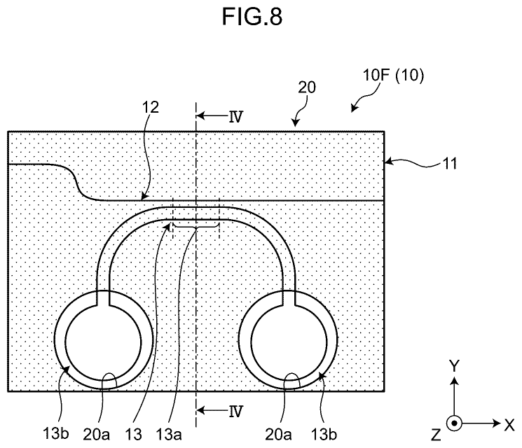

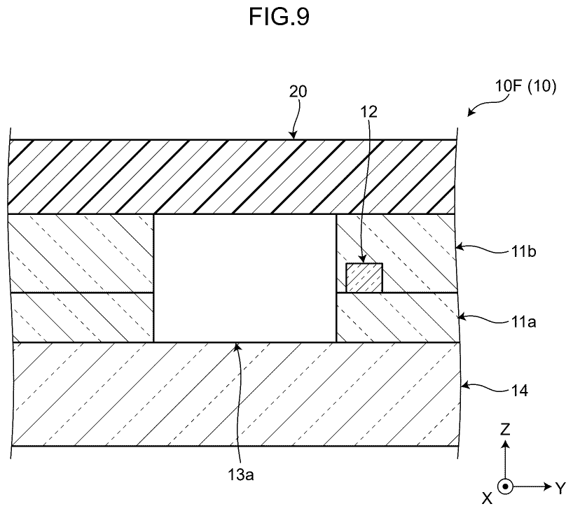

FIG. 8 is a plane view of an optical waveguide sensor 10F (10) of a sixth embodiment. FIG. 9 is a cross-sectional view of the optical waveguide sensor in FIG. 8 in the IV-IV position. In the optical waveguide sensor 10F of the present embodiment, a cover 20 is arranged on the upper cladding 11b. Holes 20a that are provided correspondingly to the reservoirs 13b are formed in the cover 20.

The cover 20 is made of resin containing COP (cyclo olefin polymer), PC (polycarbonate), PS (polystyrene), PDMS, SU-8, a Si wafer, a glass material, or the like. The cover 20 is fixed to the top of the upper cladding 11b by direct joining by plasma surface treatment or by curing an adhesive.

According to the present embodiment, it is possible to treat a fluid that is compressed by the cover 20. The cover 20 makes it possible to prevent mixture of a foreign matter with an examination object during examination and prevent the fluid that is poured into the grooves 13 from spilling.

Note that, in both the above-described first to fifth embodiments and seventh to elevenths embodiments described below, a cover may be provided as in the present embodiment. Also in other embodiments, it is possible to treat a fluid that is compressed by the cover.

Furthermore, the cover makes it possible to prevent mixture of a foreign matter with an examination object during examination and prevent the fluid that is poured into the grooves 13 from spilling.

### Seventh Embodiment

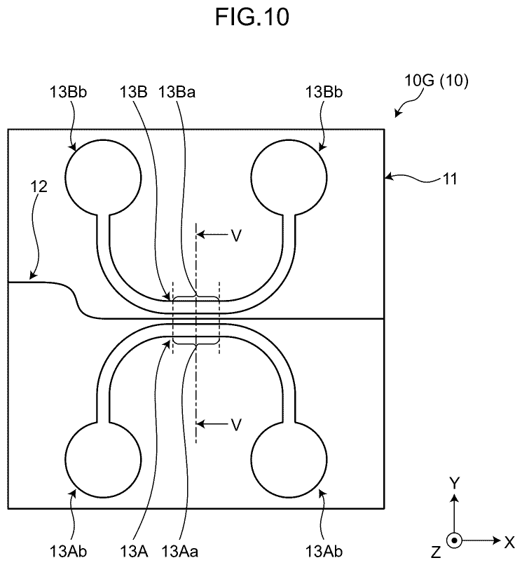

FIG. 10 is a plane view of part of an optical waveguide sensor 10G (10) of a seventh embodiment. In the optical waveguide sensor 10G, a groove includes a first groove 13A that is positioned on a side of the core 12 and the second groove 13B that is positioned on a side opposite to the first groove 13A with respect to the core 12.

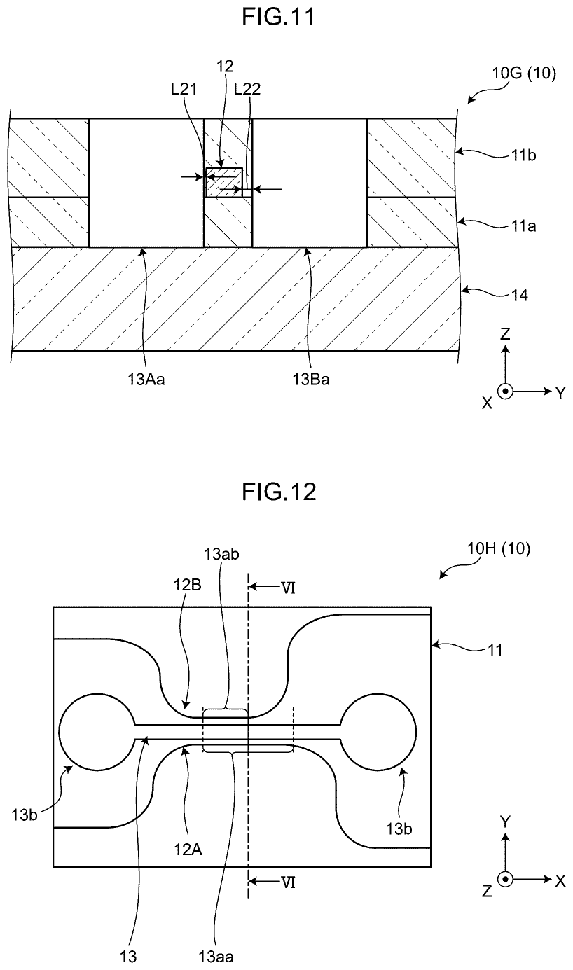

FIG. 11 is a cross-sectional view of the optical waveguide sensor in FIG. 10 in the V-V position. While a distance L21 between the core 12 and a side face of the examination area 13Aa of the first groove 13A and a distance L22 between the core 12 and a side face of the examination area 13Ba of the second groove 13B may be equal, the distances may be different as illustrated in FIG. 11. In an example where the distance L21 and the distance L22 are different, it is possible to adjust the amount of leakage of evanescent light by setting the distance L22 at 1.1 times the distance L21.

In the present embodiment, the optical waveguide sensor 10 is provided with the first groove 13A and the second groove 13B. According to such a configuration, for example, it is possible to house examination objects that are different from each other in the first groove 13A and the second groove 13B and examine the different examination objects.

### Eighth Embodiment

FIG. 12 is a plane view of an optical waveguide sensor 10H (10) of an eighth embodiment. As illustrated in FIG. 12, in the optical waveguide sensor 10H of the present embodiment, a core includes a first core 12A that extends in a given direction and that guides first examination light and a second core 12B that extends in the given direction on a side opposite to the first core 12A with respect to the groove 13 and that guides second examination light.

A length of an examination area 13aa of the groove 13 with respect to the first core 12A and a length of an examination area 13ab of the groove 13 with respect to the second core 12B may be equal or may be different.

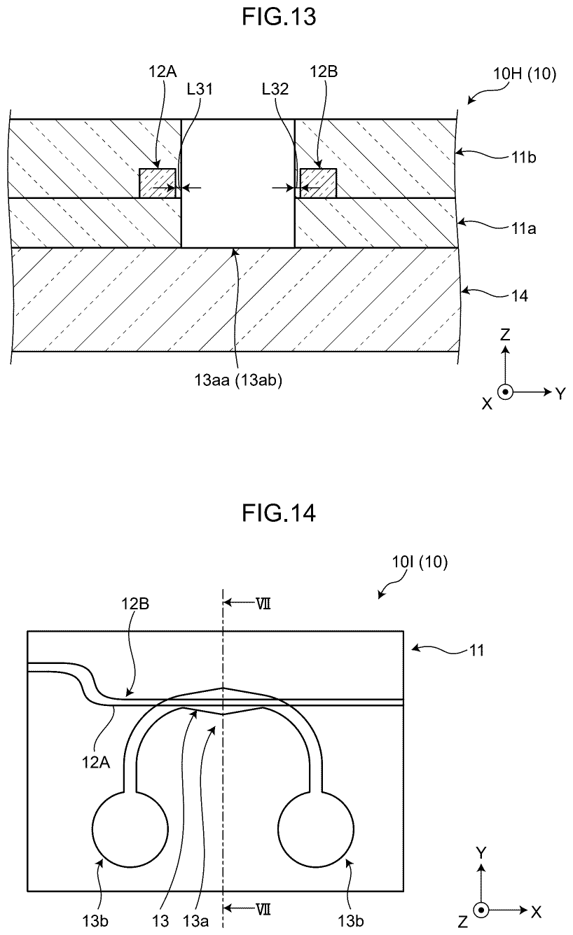

FIG. 13 is a cross-sectional view of the optical waveguide sensor in FIG. 12 in the VI-VI position. In the present embodiment, a distance L31 between the first core 12A and a side face of the examination area 13aa of the groove 13 is smaller than a distance L32 between the second core 12B and a side face of the examination area 13ab of the groove 13. Thus, an amount of leakage of evanescent light from the first core 12A is larger than an amount of leakage of evanescent light from the second core 12B. In other words, also in the present embodiment, the optical waveguide sensor 10H (10) includes two cores with different amounts of leakage of evanescent light from the side faces.

In the present embodiment, the optical waveguide sensor 10 includes the two cores (the first core 12A and the second core 12B) where the amounts of evanescent light from the side faces differ according to the length of the examination area and the distance between the core and the side face. According to the present embodiment, measuring loss intensities in the two cores with different amounts of leakage of evanescent light makes it possible to examine an examination object more accurately compared to the case where a loss intensity in one core is measured.

Note that the distance L31 and the distance L32 may be equal. In this case, it is possible to guide first examination light and second examination light of different wavelength bands to the first core 12A and the second core 12B, respectively, and examine an absorption property of the examination object with respect to each wavelength band using loss intensities in the first core 12A and the second core 12B. The distance L31 and the distance L32 may be different. In an example where the distance L31 and the distance L32 are different, it is possible to adjust the amount of leakage of evanescent light by setting the distance L32 at twice the distance L31.

### Ninth Embodiment

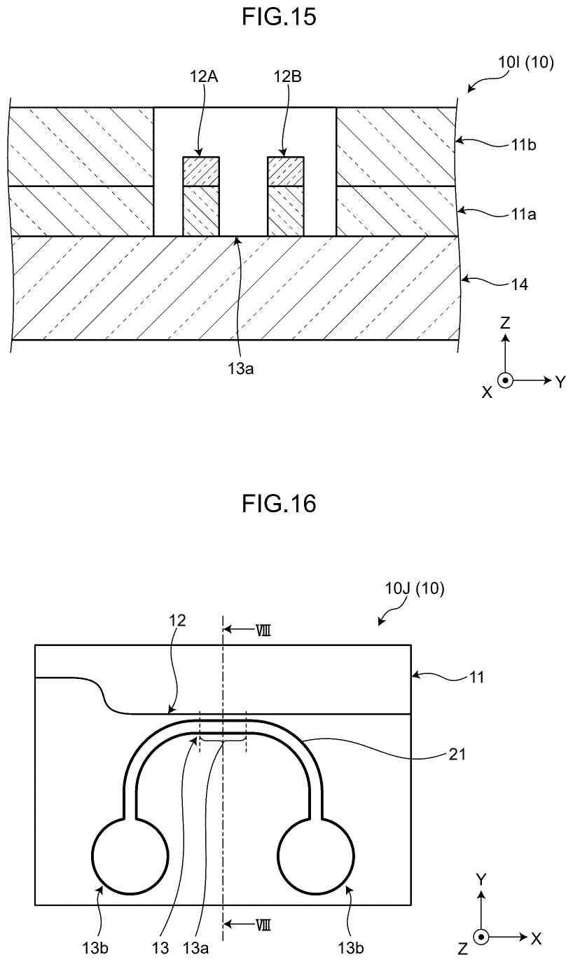

FIG. 14 is a plane view of an optical waveguide sensor 10I (10) of a ninth embodiment. FIG. 15 is a cross-sectional view of the optical waveguide sensor in FIG. 14 in the VII-VII position. As illustrated in FIG. 15, in the optical waveguide sensor 10I of the present embodiment, the upper cladding 11b is removed from both side surfaces and an upper surface in the first core 12A and the second core 12B and thus it is possible to increase detection sensitivity. Note that, in order to adjust an amount of leakage of the examination light, the upper cladding 11b may be left in a given thickness on both the side surfaces and the upper surface of the first core 12A and the second core 12B.

The upper surface of the groove 13 is positioned above the upper surfaces of the first core 12A and the second core 12B and thus a fluid that the groove 13 stores can move across and above the first core 12A and the second core 12B, which increases convenience in measuring the same examination object for multiple times.

### Tenth Embodiment

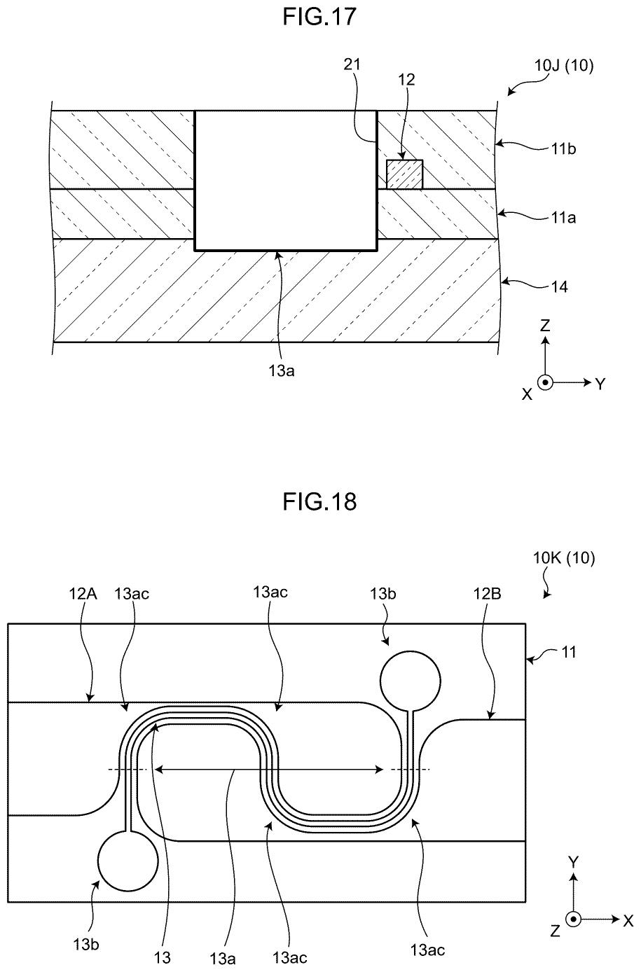

FIG. 16 is a plane view of an optical waveguide sensor 10J (10) of a tenth embodiment. FIG. 17 is a cross-sectional view of the optical waveguide sensor in FIG. 16 in the VIII-VIII position. As illustrated in FIG. 17, in the optical waveguide sensor 10J of the present embodiment, a sensitive film 21 is formed on a side face or a bottom face of the groove 13 including the examination area 13a.

The sensitive film 21 is a ligand, a receptor, or the like, that absorbs protein and is a film whose refractive index varies depending on a detection object. The sensitive film 21 is formed by flowing a fluid into the groove 13 by the sol-gel process and causing ethanol to volatize and be adsorbed to the side face and the bottom face. The sensitive film 21 may be formed by sputtering.

In the present embodiment, in the optical waveguide sensor 10, the sensitive film 21 increases a change in refractive index, which enables an increase in detection sensitivity.

### Eleventh Embodiment

FIG. 18 is a plane view of an optical waveguide sensor 10K (10) of an eleventh embodiment. As illustrated in FIG. 18, in the optical waveguide sensor 10K, the examination area 13a includes four curved portions 13ac. An amount of change in a tangential angle of each of the curved portions 13ac is 90 degrees and the total of the changes in the tangential angle is 360 degrees.

A core includes the first core 12A that extends in a given direction and that guides first examination light and the second core 12B that extends in the given direction on a side opposite to the first core 12A with respect to the groove 13 and that guides second examination light. The first core 12A is formed in a curved manner such that a surface to which examination light is input and a surface from which the examination light is output are an identical first surface. Similarly, the second core 12B is formed in a curved manner such that a surface to which examination light is input and a surface from which the examination light is output are the identical second surface. The first surface and the second surface are opposed surfaces.

In the present embodiment, in the optical waveguide sensor 10, because the examination area 13a includes the curved portions 13ac and thus the examination area 13a can be set long, it is possible to increase detection sensitivity. Furthermore, setting the amount of change in the tangential angle in the curved portions 13ac large (for example, 360 degrees or larger) makes it possible to set the examination area 13a long. The first surface and the second surface that are opposed surfaces make it possible to further reduce the work and costs necessary to manufacture the optical waveguide sensor 10 in some cases.

The embodiments of the disclosure are exemplified above and the above-described embodiments are examples and are not intended to limit the scope of the invention. It is possible to carry out the above-described embodiments in other various modes and make various omissions, replacements, combinations and changes without departing from the scope of the invention. It is possible to change and practice the specification, such as each configuration and shape, (structure, type, direction, model, size, length, width, thickness, height, number, arrangement, position, material, etc.,) as appropriate.

For example, the number of cores and grooves may be three or more. The optical waveguide sensor may include a plurality of cores with equal amounts of leakage. In this case, one of the cores may be used as a reference waveguide for referring to a loss intensity of an examination object whose properties are known.

According to the disclosure, it is possible to obtain an optical waveguide sensor and a spectroscopic analysis device that are new and improved and that make it possible to increase manufacturing accuracy more.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical waveguide sensor comprising:
a core that extends in a given direction and that guides examination light;
a cladding that has a refractive index lower than the core and that surrounds at least part of a circumference of the core; and
a groove that is positioned on a side of the core in a first direction such that an oozing component of the examination light that is guided by the core leaks, an end face of the groove being positioned on a side of a second direction orthogonal to the first direction with respect to an end of the core.

2. The optical waveguide sensor according to claim 1, wherein the groove has an examination area where a distance between the core and a face that is included in the groove and that is positioned on the side of the core in the first direction is at or under a threshold.

3. The optical waveguide sensor according to claim 2, wherein the threshold is 5 μm.

4. The optical waveguide sensor according to claim 2, wherein the examination area extends along the core.

5. The optical waveguide sensor according to claim 1, wherein the groove is a micro fluid channel configured to transfer a fluid including an examination object.

6. The optical waveguide sensor according to claim 1, wherein the cladding includes a first cladding that is positioned on the side of the core in the second direction and a second cladding that is layered on the first cladding with a step between the first cladding and the second cladding.

7. The optical waveguide sensor according to claim 1, further comprising an optical branch configured to branch the examination light.

8. The optical waveguide sensor according to claim 7, wherein the optical branch is a power splitter, a wavelength division multiplexing, a polarized beam splitter, a variable splitter, or an optical switch.

9. The optical waveguide sensor according to claim 7, wherein the optical branch is a polarized beam splitter configured to branch the examination light into a transverse electric polarized component and a transverse magnetic polarized component, and
the groove includes
a first groove that is positioned on the side of the core guiding light of the transverse electric polarized component, in the first direction, and
a second groove that has the same form as the first groove or a linearly symmetric form to the first groove and that is positioned on the side of the core guiding light of the transverse magnetic polarized component, in the first direction.

10. The optical waveguide sensor according to claim 1, wherein the core is formed in a curved manner such that a surface to which the examination light is input and a surface from which the examination light is output are an identical surface.

11. The optical waveguide sensor according to claim 1, further comprising a mold filter configured to remove higher mode components from the examination light.

12. The optical waveguide sensor according to claim 1, wherein the groove includes
a first groove that is positioned on the side of the core in the first direction, and
a second groove that is positioned on a side opposite to the first groove with respect to the core.

13. The optical waveguide sensor according to claim 1, wherein the core includes
a first core that extends in a given direction and that guides first examination light and
a second core that extends in a given direction on a side opposite to the first core with respect to the groove and that guides second examination light.

14. The optical waveguide sensor according to claim 2, wherein a sensitive film is formed in the examination area.

15. The optical waveguide sensor according to claim 2, wherein the examination area includes a curved portion.

16. The optical waveguide sensor according to claim 15, wherein the curved portion has an amount of change in a tangential angle that is 360 degrees or larger.

17. The optical waveguide sensor according to claim 13, wherein the first core is formed in a curved manner such that a surface to which the examination light is input and a surface from which the examination light is output are an identical first surface,
the second core is formed in a curved manner such that a surface to which the examination light is input and a surface from which the examination light is output are an identical second surface, and
the first surface and the second surface are opposed surfaces.

18. The optical waveguide sensor according to claim 1, wherein the core and the cladding are made of a material containing any one of SiO₂, Si, SiN, InP, GaAs, and GaN.

19. A spectroscopic analysis device comprising the optical waveguide sensor according to claim 1.
